(19) United States
(12) Patent Application Publication
(10) Pub. No.: US 2024/0310555 A1
(43) Pub. Date: Sep. 19, 2024

(54) IDENTIFICATION OF COMMONALITIES AMONG DIFFERENT DESCRIPTIONS

(71) Applicant: Chevron U.S.A. Inc., San Ramon, CA (US)

(72) Inventors: Robert Chadwick Holmes, Houston, TX (US); Hemant Kumar, Katy, TX (US)

(21) Appl. No.: 18/590,356

(22) Filed: Feb. 28, 2024

Related U.S. Application Data
(60) Provisional application No. 63/490,558, filed on Mar. 16, 2023.

(51) Int. Cl. G01V 20/00

(52) U.S. Cl. CPC G01V 20/00

(57) ABSTRACT

A similarity matrix is generated for different descriptions of one or more things. The similarity matrix includes values that indicate the extent of similarity between different pairs of descriptions. The values of the similarity matrix are clustered to generate a clustered similarity matrix, which include groupings of pair-wise similarities between the different descriptions. Commonalities between the different descriptions are identified using the groupings of pair-wise similarities.

### CROSS-REFERENCE TO RELATED APPLICATIONS

The present application claims the benefit of U.S. Provisional Application No. 63/490,558, entitled “SYSTEM AND METHOD FOR CLUSTERING MULTIDIMENSIONAL FRAMEWORKS,” which was filed on Mar. 16, 2023, the entirety of which is hereby incorporated herein by reference.

### FIELD

The present disclosure relates generally to the field of identifying commonality among different descriptions by clustering pair-wise similarities between the descriptions.

### BACKGROUND

Different words used in descriptions of things (e.g., wells, subsurface regions, projects, reports, evaluations) may make evaluation/analysis of the things difficult and time consuming. For example, descriptions of the rock characteristics in wells may use different words (e.g., individual words, phrases, abbreviations, shorthand, etc.) to describe similar characteristics. Manually reviewing and matching different descriptions of wells may be difficult, prone to bias, and not scalable.

### SUMMARY

This disclosure relates to identifying commonality among different descriptions. Description information and/or other information may be obtained. The description information may define descriptions of one or more wells in a subsurface region. Individual descriptions may include one or more words. A similarity matrix may be generated for the descriptions of the well(s) in the subsurface region. The similarity matrix may include values to indicate similarity between different pairs of the descriptions of the well(s) in the subsurface region. A clustered similarity matrix may be generated based on clustering of the values of the similarity matrix and/or other information. The clustered similarity matrix may include groupings of pair-wise similarities between the descriptions of the well(s) in the subsurface region. Commonalities between the descriptions of the well(s) in the subsurface region may be identified. Commonalities between the descriptions may be identified based on the groupings of the pair-wise similarities between the descriptions of the well(s) in the subsurface region in the clustered similarity matrix and/or other information. Characteristics of the well(s) in the subsurface region may be determined. Characteristics of the well(s) in the subsurface region may be determined based on the commonalities between the descriptions of the well(s) in the subsurface region and/or other information.

A system for identifying commonality among different descriptions may include one or more electronic storage, one or more processors and/or other components. The electronic storage may store description information, information relating to descriptions, information relating to wells information relating to subsurface regions, information relating to similarity matrix, information relating to clustered similarity matrix, information relating to commonalities between descriptions, information relating to characteristics, and/or other information.

The processor(s) may be configured by machine-readable instructions. Executing the machine-readable instructions may cause the processor(s) to facilitate identifying commonality among different descriptions. The machine-readable instructions may include one or more computer program components. The computer program components may include one or more of a description component, a similarity matrix component, a cluster component, a commonality component, a characteristic component, and/or other computer program components.

The description component may be configured to obtain description information and/or other information. The description information may define descriptions of one or more things. For example, the description information may define descriptions of one or more wells in a subsurface region. Individual descriptions may include one or more words.

In some implementations, a given description of a given well may include interpretation of rock characteristics in the given well. In some implementations, the interpretation of the rock characteristics in the given well may be enhanced with contextual words for the generation of the similarity matrix. In some implementations, the interpretation of the rock characteristics in the given well may be enhanced with contextual words using one or more natural language models.

The similarity matrix component may be configured to generate one or more similarity matrices. A similarity matrix may be generated for the descriptions of thing(s). For example, a similarity matrix may be generated for the descriptions of the well(s) in the subsurface region. A similarity matrix may include values to indicate similarity between different pairs of descriptions. For example, a similarity matrix may include values to indicate similarity between different pairs of the descriptions of the well(s) in the subsurface region. In some implementations, vectorized embeddings of the descriptions of thing(s) (e.g., the well(s) in the subsurface region) may be generated to determine the similarity between the different pairs of the descriptions of the thing(s).

The cluster component may be configured to generate one or more clustered similarity matrices. A clustered similarity matrix may be generated based on clustering of the values of a similarity matrix. A clustered similarity matrix may include groupings of pair-wise similarities between the descriptions of thing(s). For example, a clustered similarity matrix may include groupings of pair-wise similarities between the descriptions of the well(s) in the subsurface region. In some implementations, the clustering of the values of a similarity matrix may include spectral clustering of the values of the similarity matrix.

In some implementations, the values of a similarity matrix may be modified based on comparison to a threshold value before the clustering of the values of the similarity matrix. In some implementations, the threshold value may be determined based on curvature of a cumulative distribution function of the values of the similarity matrix.

The commonality component may be configured to identify commonalities between the descriptions of thing(s). The commonalities between the descriptions of thing(s) may be identified based on the groupings of pair-wise similarities in a clustered similarity matrix and/or other information. For example, the commonalities between the descriptions of the well(s) in the subsurface region may be identified based on the groupings of pair-wise similarities in a clustered similarity matrix and/or other information.

The characteristic component may be configured to determine characteristics of thing(s). The characteristics of the thing(s) may be determined based on the commonalities between the descriptions of thing(s) and/or other information. For example, the characteristics of the well(s) in the subsurface region may be determined based on the commonalities between the descriptions of the well(s) in the subsurface region and/or other information.

In some implementations, a given characteristic of a given well may include a rock type or a depositional environment type of the given well. In some implementations, conversion of the given description of the given well into the rock type or the depositional environment type of the given well may enable upscaling of a well core description of the given well into a higher level classification of the given well.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for identifying commonality among different descriptions.

FIG. 2 illustrates an example method for identifying commonality among different descriptions.

FIG. 3 illustrates an example flow diagram for identifying commonality among different descriptions.

FIG. 4 illustrates an example similarity matrix.

FIG. 5 illustrates an example modification of a similarity matrix for clustering.

FIG. 6 illustrates example eigenvalues for clustering of a similarity matrix.

FIG. 7 illustrates examples of clustering of similarity matrices.

### DETAILED DESCRIPTION

The present disclosure relates to identifying commonality among different descriptions. A similarity matrix is generated for different descriptions of one or more things. The similarity matrix includes values that indicate the extent of similarity between different pairs of descriptions. The values of the similarity matrix are clustered to generate a clustered similarity matrix, which include groupings of pair-wise similarities between the different descriptions. Commonalities between the different descriptions are identified using the groupings of pair-wise similarities.

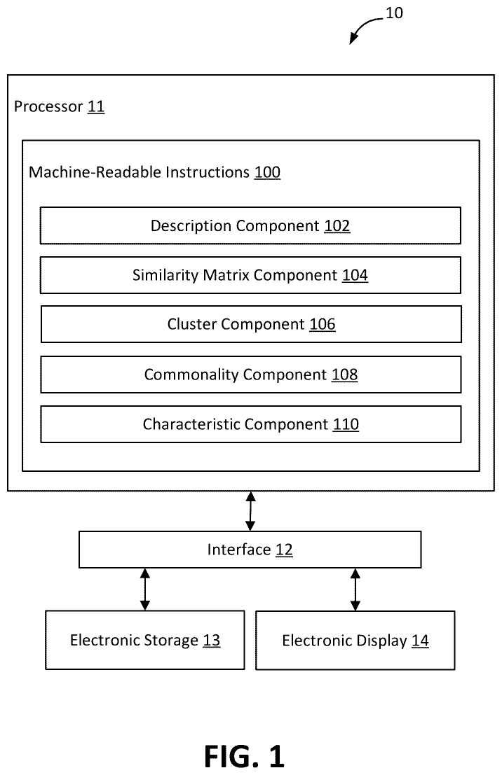

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Description information and/or other information may be obtained by the processor 11. The description information may define descriptions of one or more wells in a subsurface region. Individual descriptions may include one or more words. A similarity matrix may be generated by the processor 11 for the descriptions of the well(s) in the subsurface region. The similarity matrix may include values to indicate similarity between different pairs of the descriptions of the well(s) in the subsurface region. A clustered similarity matrix may be generated by the processor 11 based on clustering of the values of the similarity matrix and/or other information. The clustered similarity matrix may include groupings of pair-wise similarities between the descriptions of the well(s) in the subsurface region. Commonalities between the descriptions of the well(s) in the subsurface region may be identified by the processor 11. Commonalities between the descriptions may be identified based on the groupings of the pair-wise similarities between the descriptions of the well(s) in the subsurface region in the clustered similarity matrix and/or other information. Characteristics of the well(s) in the subsurface region may be determined by the processor 11. Characteristics of the well(s) in the subsurface region may be determined based on the commonalities between the descriptions of the well(s) in the subsurface region and/or other information.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store description information, information relating to descriptions, information relating to wells information relating to subsurface regions, information relating to similarity matrix, information relating to clustered similarity matrix, information relating to commonalities between descriptions, information relating to characteristics, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present description information, information relating to descriptions, information relating to wells information relating to subsurface regions, information relating to similarity matrix, information relating to clustered similarity matrix, information relating to commonalities between descriptions, information relating to characteristics, and/or other information.

A thing may be described using one or more words. A description of a thing may include one or more words, such as individual words, phrases, abbreviations, shorthand, and/or other words. A thing may refer to a physical object/entity/material or a non-physical object/entity/material. A thing may include a living thing or a non-living thing. Examples of a thing include a place/region (e.g., wells, subsurface regions, reservoirs), a piece of equipment, an object, a concept/work (e.g., projects, initiatives), and a collection of information (e.g., reports, evaluations). Other types of things are contemplated.

Different words may be used to describe a particular characteristic of a thing. For example, different people may use different words to describe a particular type of rock in a well. Use of different words to describe things may make it difficult to create a framework from which the things may be characterized (e.g., evaluated, ranked, analyzed, understood). For example, descriptions of wells in a subsurface region may use different words to describe characteristics (e.g., rock type, interpretations of depositional environment, grain size, type of porosity, presence of staining, fossils, depositional features, diagenetic features) of the wells. Use of different words to describe the wells may make it difficult to combine/synthesize the descriptions into a unified classification of wells (e.g., difficult to upscale different well core descriptions into a higher level classification of the wells). As another example, descriptions of projects/products/services may use different words to describe values provided by the projects/products/services. Use of different words to describe the values provided by the projects/products/services may make it difficult to combine/synthesize the descriptions into a unified metric from which the projects/products/services may be ranked (e.g., difficult to combine value descriptions of projects/products/services into a prioritization/value scheme).

The present disclosure provides a tool that determines similarity between descriptions of things and utilizes clusters of similar descriptions to identify commonalities between the descriptions. The commonalities between the descriptions provide a unified framework from which the things may be characterized (e.g., evaluated, ranked, analyzed, understood). For example, the tool may be used to combine/synthesize different descriptions of wells into a unified classification of the wells. As another example, the tool may be used to combine/synthesize different descriptions of projects/products/services into a unified metric from which the projects/products/services may be ranked. The tool enables additional descriptions to be added into existing analysis and provides flexibility in identifying commonalities between descriptions of things. The descriptions may be analyzed at one or multiple scales. The number of commonalities that are identified may be controlled to match the level of detail required for characterization of things.

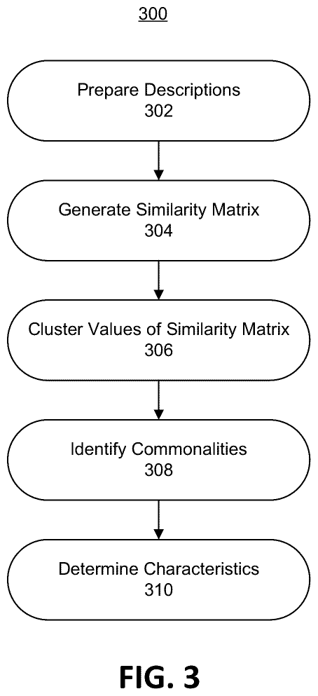

FIG. 3 illustrates an example flow diagram 300 for identifying commonality among different descriptions. At step 302, descriptions of a thing may be prepared. Preparing a description of a thing may include obtaining, processing, pre-conditioning, enriching, and/or otherwise preparing the description. Individual descriptions may include one or more words that describe the thing. The descriptions of the thing may be processed to “clean” the descriptions. For example, words in the descriptions may be converted into lowercase (for case consistency) and leading and/or trailing whitespace may be removed from the description (white space removal). The descriptions of the thing may be enhanced with contextual words. The descriptions of the thing may be enhanced by adding additional context to them (e.g., what the description was for the interval above or below in a well to capture a potential relationship that has geologic meaning). The descriptions of the thing may be enhanced using one or more natural language models and/or other models. For instance, generative machine learning/artificial intelligence may be used to add words (e.g., individual words, phrases, sentences, paragraphs) that provide context to the existing descriptions. The words in the descriptions may be expanded by rephrasing for greater context and/or via use of generative machine learning/artificial intelligence to expand the context meaning of the words in the descriptions. The words in the descriptions may be normalized into one voice and enhanced to provide more context than a person might out of a natural desire to simplify the descriptions.

At step 304, a similarity matrix may be generated for the descriptions of the thing. The similarity matrix may include values to indicate similarity between different pairs of descriptions. The values (element values) of the matrix may reflect the similarity between different pairs of descriptions. Vectorized embeddings of the descriptions may be generated to determine the similarity between the different pairs of the descriptions. For example, individual or multiple embedding models (e.g., MPNet embedding model and ada02 (GPT3) embedding model) may be used, and the resulting embeddings may be appended to one another to create a vector/array (e.g., vector/array length a+b, where a is the length of the embedding from MPNet and b is the length of the embedding from ada02).

Vectorized embeddings of the descriptions may be compared in a pairwise manner to generate the similarity matrix. For example, the embedding arrays for individual description may be converted to similarity values using cosine similarity metric. The pairwise similarities of the descriptions may be placed within the cells of a n by n matrix, where n is the number of descriptions. Individual rows and columns may correspond to one of the descriptions. The values of the similarity matrix may reflect how similar vectorized embeddings of the descriptions are to each other.

The values of the similarity matrix may be transformed using a threshold so that values below the threshold are replaced with zero and values above the threshold are replaced with one. Such transformation of values enhances the similarity contrast of the descriptions being compared. Without such transformation of values, the similarity matrix may include values with a small dynamic range, which may make it harder to identify different clusters. Such transformation of values makes the similarity matrix like a graph representation where an element with the value of one represents connection between two descriptions, with each description represented as a graph node. The threshold may be determined based on curvature of a cumulative distribution function of the values of the similarity matrix.

At step 306, values of the similarity matrix may be clustered to generate a clustered similarity matrix. The clustered similarity matrix may include groupings of pair-wise similarities between the descriptions of the thing. For example, the values of the similarity matrix may be clustered using spectral clustering, where the matrix normalized Laplacian is computed and then decomposed into eigenvalues and eigenvectors. The Silhoutte and Calinski-Harabasz scores may be calculated on the results of k-means clustering using a variable number of eigenvectors (k). Maxima in both scores may be used to determine how many clusters will be formed, i.e., what value of “k” should be used.

At step 308, commonalities between the descriptions of the thing may be identified based on the groupings of pair-wise similarities in the clustered similarity matrix. The clusters/groupings within the clustered similarity matrix may be summarized as commonalities (e.g., distinct themes, dimensions, metrics) between the descriptions of the thing. For example, individual clusters/groupings within the clustered similarity matrix may be converted into words (e.g., individual words, phrases, sentences, paragraphs) using human intuition from subject matter experts and/or generative machine learning/artificial intelligence.

At step 310, characteristics of the thing may be determined based on the commonalities between the descriptions of thing. The commonalities between the descriptions of the thing may be used to convert different words within the descriptions into characteristics of the thing. The commonalities between the descriptions of the thing may be used as a framework from which the thing is characterized (e.g., evaluated, ranked, analyzed, understood).

While some implementations of the present disclosure are described with respect to wells and subsurface regions, this is merely an example and is not meant to be limiting. The present disclosure may be applied to other types of physical things and other types of non-physical things (e.g., projects, reports, evaluations, file classification). For example, while some implementations of the present disclosure are described with respect to identification of rock types in wells/subsurface regions, the present disclosure may be applied to identify dimensions/metrics to characterize other things. For instance, the present disclosure may be used in file classification for information management and later retrieval when certain information is desired (e.g., all studies, reports, and evaluations related to a region that may be useful for conducting regional studies on the region).

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate identifying commonality among different descriptions. The machine-readable instructions 100 may include one or more computer program components. The machine-readable instructions 100 may include one or more of a description component 102, a similarity matrix component 104, a cluster component 106, a commonality component 108, a characteristic component 110, and/or other computer program components.

The description component 102 may be configured to obtain description information and/or other information. Obtaining description information may include one or more of accessing, acquiring, analyzing, creating, determining, examining, generating, identifying, loading, locating, measuring, opening, receiving, retrieving, reviewing, selecting, storing, utilizing, and/or otherwise obtaining the description information. The description component 102 may obtain description information from one or more locations. For example, the description component 102 may obtain description information from a storage location, such as the electronic storage 13, electronic storage of a device accessible via a network, and/or other locations. The description component 102 may obtain description information from one or more hardware components (e.g., a computing device) and/or one or more software components (e.g., software running on a computing device). Description information may be stored within a single file or multiple files.

The description information may define descriptions of one or more things. Individual descriptions may include one or more words. A description of a thing may include words, phrases, abbreviations, shorthand, sentences, paragraphs, and/or other forms of words/combinations of words. A description of a thing may provide a statement or an account that details the characteristics of the thing. A description of a thing may refer to a concept of the thing. The description information may define a description of a thing by characterizing, describing, identifying, quantifying, reflecting, and/or otherwise defining the description of the thing. The description information may define a description of a thing by including information that defines one or more content, qualities, attributes, features, and/or other aspects of the description of the thing. For example, the description information may define a description of a thing by including information that specifies words that form the description of the thing. Other types of description information are contemplated.

For example, the description information may define descriptions of one or more wells in a subsurface region. A well may refer to a hole that is drilled in the ground. A well may be drilled in the ground for exploration and/or recovery of resources in the ground, such as water or hydrocarbons. The term “wellbore,” “well bore,” “borehole,” and the like may be utilized interchangeably with the term “well.” A subsurface region may refer to a part of earth located beneath the surface/located underground. A subsurface region may refer to a part of earth that is not exposed at the surface of the ground. A subsurface region may include and/or be part of a reservoir or a field.

In some implementations, a description of a well may include interpretation of rock characteristics in the well. For example, a description of a well may include interpretation of well logs, seismic data, well cores, and/or other information on the well into rock characteristics in the well. A description of a well may include interpretation of what types of rocks are present in the well. A description of a well may include interpretation of the types of rocks at different locations along the well.

The description information may be processed and/or enhanced for use. For example, descriptions of a thing from multiple data sources may be combined into a single list of words, phrases, and/or longer-form content depending on the use case. The list may include the exact words found in the original data sources. The list may be enhanced (e.g., augmented, expanded, enriched), such as by rephrasing the original words for great context and/or by generating new words to expand the contextual meaning of the original words. For example, the description information may include keywords for a thing, and the description of the thing may be enhanced by adding human/machine-enriched words.

For example, in the case of a description of a well, the interpretation of the rock characteristics in the well may be enhanced with contextual words. Contextual words may refer to words that add context to the original words. Different types of contextual words may be added based on different context in which the original words are used. The interpretation of the rock characteristics in the well may be enhanced with contextual words for generation of a similarity matrix. The contextual words may be generated using human subject matter experts and/or machine learning/artificial intelligence. For example, the interpretation of the rock characteristics in a well may be enhanced with contextual words using one or more natural language models. The natural language model(s) may be tuned to geoscience ontologies.

For example, the words in the description may be passed through one or more natural language models that convert the freeform text of the description into an embedding space of fixed dimensions. If multiple models are used, the embeddings may be combined for an expanded representation vector. The embedding versions of individual description may then be compared, pairwise, by running a similarity measure, and the pairwise groupings may be composed into an n by n matrix, where n is the original number of descriptions. The matrix may be transformed through a clustering routine, and the final clusters may be summarized to represent distinct descriptive themes in the original group of descriptions (i.e., a consolidated new framework).

The similarity matrix component 104 may be configured to generate one or more similarity matrices. Generating a similarity matrix may include calculating, creating, determining, estimating, populating, producing, quantifying, storing, utilizing, and/or otherwise generating the similarity matrix. A similarity matrix may refer to a matrix that defines pairwise similarity of elements. A similarity matrix may include values that reflect the extent of pairwise similarity of elements. The value for a pair of descriptions may indicate the extent of similarity/strength of connection between the pair of descriptions.

A similarity matrix may be generated for the descriptions of thing(s). For example, a similarity matrix may be generated for the descriptions of the well(s) in the subsurface region. A similarity matrix may include values to indicate similarity between different pairs of descriptions. For example, a similarity matrix may include values to indicate similarity between different pairs of the descriptions of the well(s) in the subsurface region. A similarity matrix may be generated to create linkage between different descriptions of the thing. A similarity matrix may be generated to identify commonalities between the different descriptions of the thing. A similarity matrix may be generated to identify unique/isolated commonalities between the different descriptions and remove cross-over/overlapping commonalities between the different descriptions.

In some implementations, vectorized embeddings of the descriptions of thing(s) (e.g., the well(s) in the subsurface region) may be generated to determine the similarity between the different pairs of the descriptions of the thing(s). The vectorized embeddings of the descriptions may be computed using one or more natural language models. The vectorized embeddings of the descriptions may be compared to determine the element values of the similarity matrix. For example, the vectorized embeddings may be run through a similarity operation (e.g., cosine similarity) to determine a decimal similarity value for every pair of descriptions. The value of an element of the similarity matrix may indicate the similarity between the vectorized embeddings of the corresponding descriptions.

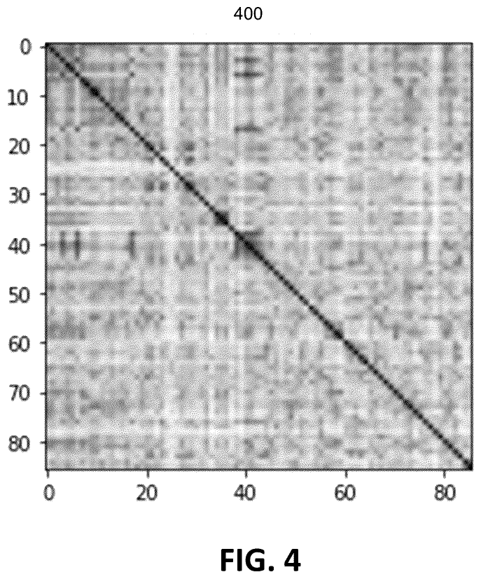

FIG. 4 illustrates an example similarity matrix 400. The element values of the similarity matrix 400 may range between two numbers, such as zero and one. The element value of the similarity matrix 400 may indicate similarity between different pairs of descriptions. For example, an element of the similarity matrix at row R and column C may indicate similarity between description represented by row R and the description represented by column C. For example, an element value of zero may indicate that the two descriptions are dissimilar (no linkage), an element value of one may indicate that the two descriptions are similar (linkage), and an element value between zero and one may indicate that the two descriptions are partially similar (partial linkage). In FIG. 4, the darker regions may correspond to description pairs with high similarity, while the brighter regions may correspond to description pairs with low/no similarity.

The cluster component 106 may be configured to generate one or more clustered similarity matrices. Generating a clustered similarity matrix may include calculating, creating, determining, estimating, populating, producing, quantifying, storing, utilizing, and/or otherwise generating the clustered similarity matrix. A clustered similarity matrix may refer to a similarity matrix in which elements that are similar to each other have been grouped together. A clustered similarity matrix may refer to a similarity matrix in which similarity elements have been grouped together.

A clustered similarity matrix may be generated based on clustering of the values of a similarity matrix. The position at which different descriptions are represented within the similarity matrix may be changed to generate the clustered similarity matrix. For example, the row and the column at which a particular description is represented within a similarity matrix may be changed to generate the clustered similarity matrix. The rows and the columns at which the descriptions are represented may be changed via clustering so that similar descriptions are represented next to/near each other within the clustered similarity matrix. The rows and the columns at which the descriptions are represented may be changed via clustering so that related value elements appear close to each other along the diagonal of the clustered similarity matrix.

A clustered similarity matrix may include groupings of pair-wise similarities between the descriptions of thing(s). Pair-wise similarity that are similar to each other may be grouped together. For example, a clustered similarity matrix may include groupings of pair-wise similarities between the descriptions of the well(s) in the subsurface region. Clusters within a clustered similarity matrix may reveal the common geologic themes spanning all of the descriptions included in the analysis. Choices for the optimal number of clusters may be determined from visual inspection of the similarity matrix and/or using spatial statistical metrics applied to the clusters. In some implementations, the clustering of the values of a similarity matrix may include spectral clustering of the values of the similarity matrix. The matrix normalized Laplacian may be computed and then decomposed into eigenvalues and eigenvectors. The Silhoutte and Calinski-Harabasz scores may be calculated on the results of k-means clustering using a variable number of eigenvectors (k). Maxima in both scores may be used to determine how many clusters are generated in the clustered similarity matrix. In some implementations, the values of a similarity matrix may be clustered using strongly connected matrix. The similarity matrix may be treated as a graph, where each high rank pair forms a connection. A reachability matrix may be generated and used to generate a strong-connected element matrix, which may be used for clustering. In some implementations, the values of a similarity matrix may be clustered using simulated annealing, which clusters through optimization routine. The elements of the similarity matrix may be randomly assigned to k clusters, and the elements and the cluster number may be changed if the objective function (e.g., silhouette score) shows improvement. In some implementations, the values of a similarity matrix may be clustered using hierarchical/agglomerative clustering.

In some implementations, the clustering of the values of a similarity matrix may be performed with use of generative machine learning/artificial intelligence. For example, a natural language model may be prompted to cluster the descriptions into non-overlapping groups, with the individual descriptions provided in a delimited list. The groupings provided by the natural language model may be used to cluster the values of a similarity matrix. In some implementations, the natural language model may be prompted to cluster the descriptions into a certain number of non-overlapping groups. Use of other clustering techniques are contemplated.

In some implementations, the values of a similarity matrix may be modified based on comparison to a threshold value before the clustering of the values of the similarity matrix. Based on whether the values of the similarity matrix are higher or lower than the threshold value, the values of the similarity matrix may be changed. For example, the values of the similarity matrix that are higher than the threshold value may be changed to a certain value (e.g., one) while the values of the similarity matrix that are lower than the threshold value may be changed to a different value (e.g., zero). The values of the similarity matrix may be compared to the threshold value to convert the similarity matrix into a binary similarity matrix, with the element values being one or two values. Such modification of the similarity matrix enables strong differentiation of the element values.

In some implementations, the threshold value may be determined based on curvature of a cumulative distribution function of the values of the similarity matrix. For example, the threshold value to which the values of the similarity matrix are compared for generation of the binary similarity matrix may be determined using the cumulative distribution function of the values of the similarity matrix. The cumulative distribution function may be computed for the elements of the similarity matrix, and a particular point along the cumulative distribution function may be selected as the threshold value. For instance, the “knee” or the point of maximum curvature on the upper half of the cumulative distribution function curve is selected as the threshold value. The threshold value may be adjusted (e.g., by an additional offset, such as −0.03) to capture a slightly different (e.g., lower/higher) threshold. Other determination of threshold value is contempt.

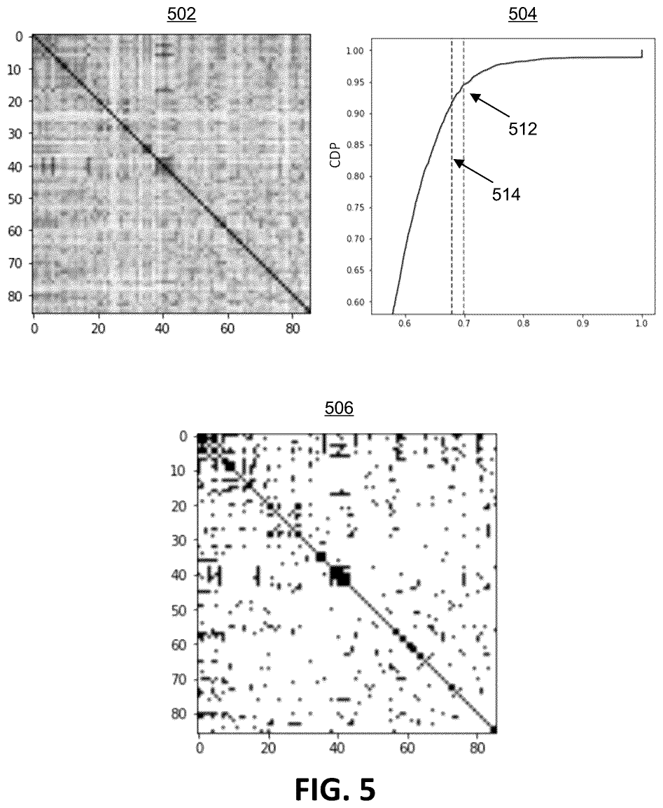

FIG. 5 illustrates an example modification of a similarity matrix 502 for clustering. A cumulative distribution function of the similarity matrix may be computed and plotted as a curve 504. The point of maximum curvature may be identified as knee/elbow 512. A threshold 514 may be identified based on the knee/elbow 512. For example, in FIG. 5, the threshold 514 may be identified to be 0.03 less than the knee/elbow 512. The similarity matrix 502 may be transformed into a binary similarity matrix 506 based on the threshold 514. For example, values of the similarity matrix 502 below the threshold 514 may be set to zero while values of the similarity matrix 502 above the threshold 514 may be set to one. The binary similarity matrix 506 may emphasize highly similar descriptions while suppressing general similarity between the descriptions.

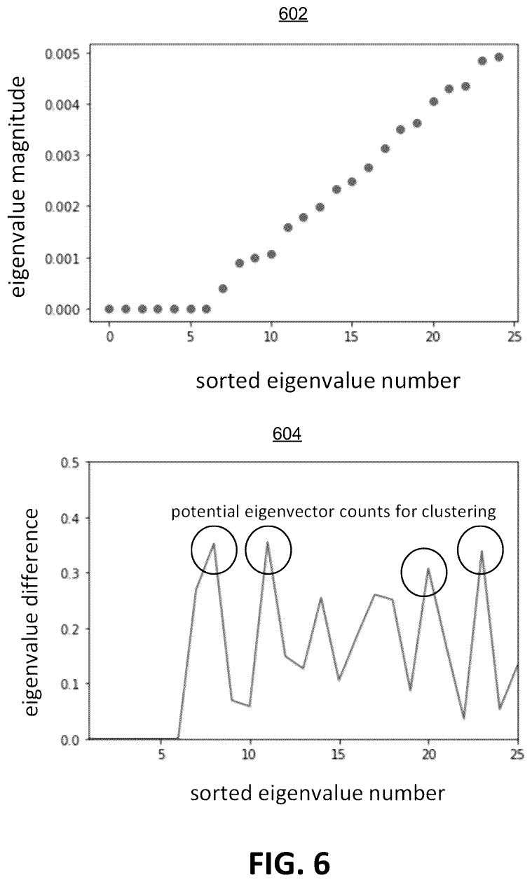

FIG. 6 illustrates example eigenvalues for clustering of a similarity matrix. FIG. 6 shows a plot 602 of eigenvalue magnitude versus sorted eigenvalue number and a plot 604 of eigenvalue difference versus sorted eigenvalue number. A useful artifact of spectral clustering is the generation of Laplacian eigenvalues (λ) in the process, which may be plotted as shown in FIG. 6. The count of zero-value λs corresponds to a natural separation of the value elements into separable clusters, in this case totaling six. In addition, points of large relative steps in successive eigenvalue magnitudes may highlight alternate cluster counts. Peaks can be seen in the plot 604, which is created by taking a two-point rolling difference between successive sorted eigenvalue numbers to highlight value “steps,” with individual peaks corresponding to different clustering of the similarity matrix. The eigenvalue numbers at the peaks may be used as the number of clusters to be formed in the similarity matrix.

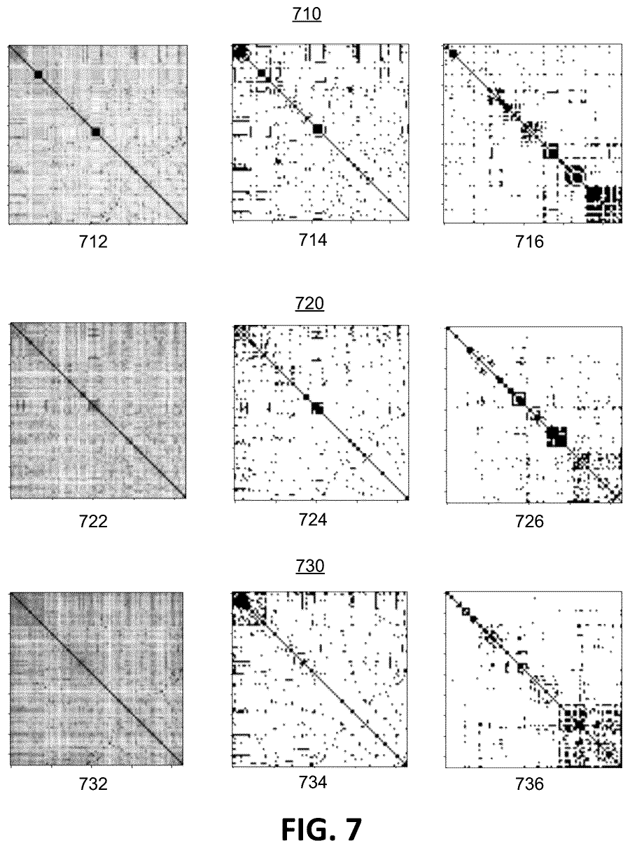

FIG. 7 illustrates examples of clustering of similarity matrices. In clustering 710, a similarity matrix 712 indicates similarity between different keywords that describe a thing. The similarity matrix 712 is transformed into a binary similarity matrix 714, which is then transformed into a clustered similarity matrix 716. In clustering 720, a similarity matrix 722 indicates similarity between different phrases that describe the thing. The similarity matrix 722 is transformed into a binary similarity matrix 724, which is then transformed into a clustered similarity matrix 726. In clustering 730, a similarity matrix 732 indicates similarity between different full paragraphs that describe the thing. The similarity matrix 732 is transformed into a binary similarity matrix 734, which is then transformed into a clustered similarity matrix 736. Using different levels of descriptions (e.g., keywords, phrases, full paragraphs) results in different commonalities/concepts being identified within the descriptions.

The commonality component 108 may be configured to identify commonalities between the descriptions of thing(s). Identifying a commonality between the descriptions of a thing may include ascertaining, approximating, calculating, determining, establishing, estimating, finding, obtaining, quantifying, selecting, setting, and/or otherwise identifying the commonality between the descriptions of the thing. A commonality between the descriptions of a thing may refer to feature(s), attribute(s), and/or characteristic(s) that are shared between the descriptions of the thing. The commonalities between the descriptions of the thing provide a unified framework from which the things may be characterized (e.g., evaluated, ranked, analyzed, understood). Commonalities between the descriptions of a thing may include classifications, groupings, themes, dimensions, metrics, and/or other grouped descriptions of the thing. For example, commonalities between the descriptions of a well may include rock types/lithotypes that are described by the descriptions of the well. Other types of commonalities between the descriptions of a thing are contemplated.

The commonalities between the descriptions of thing(s) may be identified based on the groupings of pair-wise similarities in a clustered similarity matrix and/or other information. For example, the commonalities between the descriptions of the well(s) in the subsurface region may be identified based on the groupings of pair-wise similarities in a clustered similarity matrix and/or other information. Individual groupings of pair-wise similarities in the clustered similarity matrix may be identified as a commonality between the descriptions. Individual clusters in the clustered similarity matrix may be identified as a commonality between the descriptions. Thus, commonalities between disparate descriptions of a thing may be found in the clustered similarity matrix. For example, the rock types/lithotypes that are described in disparate descriptions of a well may be found in the clustered similarity matrix.

In some implementations, the commonalities between the descriptions of thing(s) may be identified using generative machine learning/artificial intelligence. For example, descriptions that are in the same commonality may be input into a natural language model to generate words (e.g., shorthand name, summary, theme) that describe the commonality. Individual clusters/groupings within the clustered similarity matrix may be converted into words (e.g., individual words, phrases, sentences, paragraphs) using generative machine learning/artificial intelligence.

The characteristic component 110 may be configured to determine characteristics of thing(s). Determining a characteristic of a thing may include ascertaining, approximating, calculating, establishing, estimating, finding, identifying, obtaining, quantifying, selecting, setting, and/or otherwise determining the characteristic of the thing. A characteristic of a thing may refer to an attribute, a feature, a quality, and/or other characteristic of the thing. The characteristics of the thing(s) may be determined based on the commonalities between the descriptions of thing(s) and/or other information. For example, the characteristics of the well(s) in the subsurface region may be determined based on the commonalities between the descriptions of the well(s) in the subsurface region and/or other information. The commonalities between the description of the thing may be used to convert different words within the descriptions into characteristics of the thing. The commonalities between the description of the thing may be used as a unified framework from which the thing is characterized (e.g., evaluated, ranked, analyzed, understood).

For example, a characteristic of a well may include a rock type or a depositional environment type of the well. The commonalities between the descriptions of the well may be used to determine the rock type or the depositional environment type of the well. The commonalities between the descriptions of the well may be used to convert different words within the descriptions of the well into the rock type in the well (e.g., where/depths at which particular rock type is located in the well) or into the depositional environment type of the well (e.g., the different depositional environment in which different depths of the well were deposited). For instance, commonalities in well core description may be used to convert disparate descriptions of well cores into classification of rock types/depositional environment types. The conversion of a description of a well into the rock type or the depositional environment type of the well may enable upscaling of a well core description of the well into a higher level classification of the well. The well core description may describe the well at one scale while the rock type/depositional environment type may be provided at a higher scale. Such identification and use of commonalities between descriptions of the wells enables the wells to be analyzed/classified automatically, quickly, and consistently (without bias). Such identification and use of commonalities between descriptions of the wells enables scalable analysis of wells. Commonalities between descriptions of the wells may be re-identified when new descriptions of wells are obtained and the identified commonalities may be used to analyze numerous wells. Other types of characteristics and other uses of the commonalities between descriptions are contemplated.

For example, descriptions of well core descriptions and/or drilling logs of a well may include information on observations about the characteristics of rock in the well, such as color, grain size, presence of fossils, and depositional or structural features. Different subject matter experts, such as geologists, may describe the same rock differently, and the descriptions may be provided a much deeper level of detail than needed by wireline well log or seismic interpreters, let alone earth scientists responsible for building geomodels. The techniques described herein may be used to facilitate understanding of the similarity and contextual relatedness of the core descriptions that aggregate up to the interpretive high-level classification (e.g., lithology, environment of deposition). The core descriptions may be computed and translated into rock lithotypes or depositional environments. The techniques described herein may be applied to core descriptions from one core interpreted by more than one person, on multiple cores described by the same person, or on multiple cores described by multiple people to produce a semi-automated classification of the core into higher-order geologic clusters. This classification can define a new log that supports wireline-scale or seismic scale interpretation or feeds into the creation of a geomodel along with other integrated data products.

For instance, the core descriptions may be embedded into vector space and clustered based on their embeddings. Clusters of embeddings may be individually labeled as different types of rock, and these cluster labels may be used to convert the words in the core descriptions into rock types at depth/distance along the well. Such classification of rock may be used to determine how rock types are changing along the well and/or where similar types of rock exist throughout the well. The techniques described herein may be used to convert large amounts of data into lithotypes, even when the descriptions use different words to describe the same lithotypes.

As stated above, application of the present disclosure to wells/subsurface region is merely an example and is not meant to be limiting. The present disclosure may be applied to other types of things. For example, the present disclosure may be applied for other earth science purposes. As another example, the present disclosure may be applied for health and safety engineering (HSE) purposes. There may be Standard Operating Procedures (SOPs) for doing tasks in HSE operations. The SOPs may have been developed based on years of experience and the SOPs may continue to evolve based on new information, new failure points, and/or new technologies. Incident reports may be filed when there is a failure due to a reason which was not previously thought about. Different incident investigators may describe the same incident differently and they may recommend different changes to the SOPs. The techniques described herein may leverage machine learning to extract thematic connections between different observations made by different incident investigators. Based on these themes (commonalities), a consistent and comprehensive set of changes may be identified and recommended to an existing SOP. The benefit of this approach is to reduce human biases when it comes to making changes to the SOPs. This approach also eliminates the risks of human cognition limits that may result in information overlook when a large amount of unstructured data is presented in incident reports that are filed by different investigators.

In some implementations, one or more operations may be facilitated based on the characteristics of thing(s) and/or other information. Facilitating an operation may include assisting, automating, carrying out, controlling, designing, enabling, implementing, initiating, performing, planning, scheduling, setting up, and/or otherwise facilitating, the operation. For example, an operation at a well may be facilitated based on the characteristic(s) of the well and/or other information. For instance, an operation at a well may be facilitated based on rock types in the well and/or the environment of deposition for different parts of the well. For example, completion and/or production operations for the well may be designed, changed, implemented, and/or otherwise performed based on the rock types in the well and/or the environments of deposition for different parts of the well. Different completion and/or production operations may be performed at the well based on different rock types and/or different environments of deposition for the well. Other facilitations of operations are contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

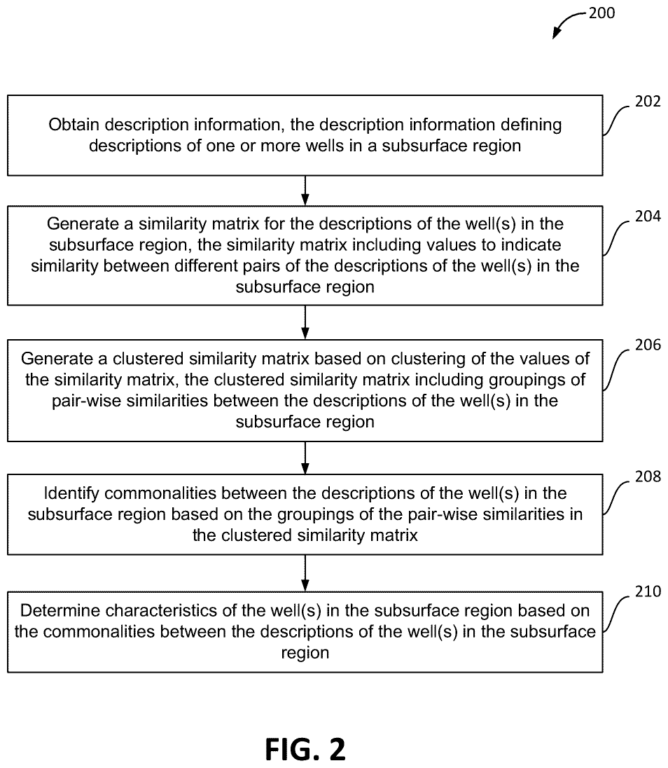

FIG. 2 illustrates a method 200 for identifying commonality among different descriptions. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, description information may be obtained. The description information may define descriptions of one or more wells in a subsurface region. Individual descriptions may include one or more words. In some implementations, operation 202 may be performed by a processor component the same as or similar to the description component 102 (Shown in FIG. 1 and described herein).

At operation 204, a similarity matrix may be generated for the descriptions of the well(s) in the subsurface region. The similarity matrix may include values to indicate similarity between different pairs of the descriptions of the well(s) in the subsurface region. In some implementations, operation 204 may be performed by a processor component the same as or similar to the similarity matrix component 104 (Shown in FIG. 1 and described herein).

At operation 206, a clustered similarity matrix may be generated based on clustering of the values of the similarity matrix. The clustered similarity matrix may include groupings of pair-wise similarities between the descriptions of the well(s) in the subsurface region. In some implementations, operation 206 may be performed by a processor component the same as or similar to the cluster component 106 (Shown in FIG. 1 and described herein).

At operation 208, commonalities between the descriptions of the well(s) in the subsurface region may be identified based on the groupings of the pair-wise similarities in the clustered similarity matrix. In some implementations, operation 208 may be performed by a processor component the same as or similar to the commonality component 108 (Shown in FIG. 1 and described herein).

At operation 210, characteristics of the well(s) in the subsurface region may be determined based on the commonalities between the descriptions of the well(s) in the subsurface region. In some implementations, operation 210 may be performed by a processor component the same as or similar to the characteristic component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for identifying commonality among different descriptions, the system comprising:
one or more physical processors configured by machine-readable instructions to:
obtain description information, the description information defining descriptions of one or more wells in a subsurface region, individual descriptions including one or more words;
generate a similarity matrix for the descriptions of the one or more wells in the subsurface region, the similarity matrix including values to indicate similarity between different pairs of the descriptions of the one or more wells in the subsurface region;
generate a clustered similarity matrix based on clustering of the values of the similarity matrix, the clustered similarity matrix including groupings of pair-wise similarities between the descriptions of the one or more wells in the subsurface region;
identify commonalities between the descriptions of the one or more wells in the subsurface region based on the groupings of the pair-wise similarities in the clustered similarity matrix; and
determine characteristics of the one or more wells in the subsurface region based on the commonalities between the descriptions of the one or more wells in the subsurface region.

2. The system of claim 1, wherein a given description of a given well includes interpretation of rock characteristics in the given well.

3. The system of claim 2, wherein a given characteristic of the given well includes a rock type or a depositional environment type of the given well.

4. The system of claim 3, wherein conversion of the given description of the given well into the rock type or the depositional environment type of the given well enables upscaling of a well core description of the given well into a higher level classification of the given well.

5. The system of claim 2, wherein the interpretation of the rock characteristics in the given well is enhanced with contextual words for the generation of the similarity matrix.

6. The system of 5, wherein the interpretation of the rock characteristics in the given well is enhanced with contextual words using a natural language model.

7. The system of claim 1, wherein vectorized embeddings of the descriptions of the one or more wells in the subsurface region are generated to determine the similarity between the different pairs of the descriptions of the one or more wells in the subsurface region.

8. The system of claim 1, wherein the values of the similarity matrix are modified based on comparison to a threshold value before the clustering of the values of the similarity matrix.

9. The system of claim 8, wherein the threshold value is determined based on curvature of a cumulative distribution function of the values of the similarity matrix.

10. The system of claim 1, wherein the clustering of the values of the similarity matrix includes spectral clustering of the values of the similarity matrix.

11. A method for identifying commonality among different descriptions, the method comprising:
obtaining description information, the description information defining descriptions of one or more wells in a subsurface region, individual descriptions including one or more words;
generating a similarity matrix for the descriptions of the one or more wells in the subsurface region, the similarity matrix including values to indicate similarity between different pairs of the descriptions of the one or more wells in the subsurface region;
generating a clustered similarity matrix based on clustering of the values of the similarity matrix, the clustered similarity matrix including groupings of pair-wise similarities between the descriptions of the one or more wells in the subsurface region;
identifying commonalities between the descriptions of the one or more wells in the subsurface region based on the groupings of the pair-wise similarities in the clustered similarity matrix; and
determining characteristics of the one or more wells in the subsurface region based on the commonalities between the descriptions of the one or more wells in the subsurface region.

12. The method of claim 11, wherein a given description of a given well includes interpretation of rock characteristics in the given well.

13. The method of claim 12, wherein a given characteristic of the given well includes a rock type or a depositional environment type of the given well.

14. The method of claim 13, wherein conversion of the given description of the given well into the rock type or the depositional environment type of the given well enables upscaling of a well core description of the given well into a higher level classification of the given well.

15. The method of claim 12, wherein the interpretation of the rock characteristics in the given well is enhanced with contextual words for the generation of the similarity matrix.

16. The method of 15, wherein the interpretation of the rock characteristics in the given well is enhanced with contextual words using a natural language model.

17. The method of claim 11, wherein vectorized embeddings of the descriptions of the one or more wells in the subsurface region are generated to determine the similarity between the different pairs of the descriptions of the one or more wells in the subsurface region.

18. The method of claim 11, wherein the values of the similarity matrix are modified based on comparison to a threshold value before the clustering of the values of the similarity matrix.

19. The method of claim 18, wherein the threshold value is determined based on curvature of a cumulative distribution function of the values of the similarity matrix.

20. The method of claim 11, wherein the clustering of the values of the similarity matrix includes spectral clustering of the values of the similarity matrix.
